(19) United States
(12) Patent Application Publication
(10) Pub. No.: US 2013/0177705 A1
(43) Pub. Date: Jul. 11, 2013

(54) APPLYING BOND COAT USING COLD SPRAYING PROCESSES AND ARTICLES THEREOF

(71) Applicants: EKLAVYA CALLA, Bangalore (IN); SUNDAR AMANCHERLA, Bangalore (IN); KRISHNAMURTHY ANAND, Bangalore (IN)

(72) Inventors: EKLAVYA CALLA, Bangalore (IN); SUNDAR AMANCHERLA, Bangalore (IN); KRISHNAMURTHY ANAND, Bangalore (IN)

(73) Assignee: GENERAL ELECTRIC COMPANY, Schenectady, NY (US)

(21) Appl. No.: 13/344,290

(22) Filed: Jan. 5, 2012

(51) Int. Cl. B05D 1/36; F01D 25/00; B05D 1/34

(52) U.S. Cl. 427/201; 415/200

(57) ABSTRACT

A process for applying a bond coat layer to a substrate includes cold spraying a first powdered material onto a surface of the substrate at a first velocity, wherein the first powdered material has a first particle size distribution; and cold spraying a second powdered material onto the surface at a second velocity to form the bond coat layer, wherein the second powdered material has a second particle size distribution and the bond coat layer comprises a microstructure comprising at least the first and second particle sizes.

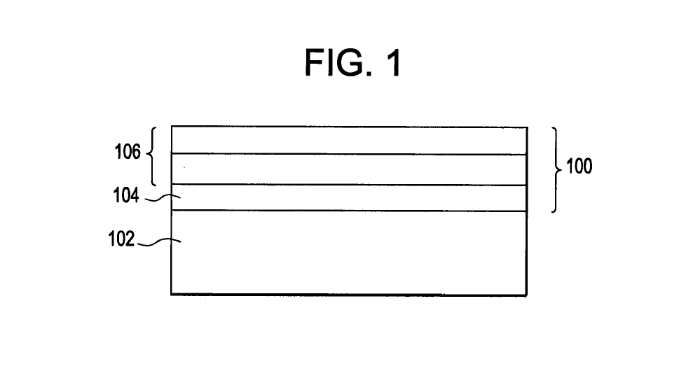

### BACKGROUND OF THE INVENTION

The subject matter disclosed herein relates to processes for applying the bond coat layer of a wear resistant coating and, more particularly, to cold spraying processes for applying the bond coat layer.

Hard wear resistant coatings, environmental barrier coatings, and the like are used in many industrial applications to prevent wear, degradation, and damage to vital components in harsh environments. If a crack were to initiate in the hard coating, it could propagate down to the interface between the component substrate and the coating. This can generally lead to coating spallation. Conventionally, these coatings are applied by thermal spraying, low-pressure plasma spray, or the like. However, low fracture toughness of the sprayed coatings makes it easier for the crack to propagate.

Bond coat layers in the hard wear resistant coatings can aid in strengthening the coating-substrate interface, but the bond coat must be ductile enough to stop or slow down the crack propagating through the coating in order to substantially reduce failure of the coatings. Unfortunately, the conventional spraying and deposition processes used to apply the coatings can not produce a bond coat layer with sufficient ductility to prevent or substantially reduce these problems. Moreover, conventional processes, such as thermal spraying, can introduce oxide layers into the hard coatings due to the temperatures used for spraying. The oxide layers and internal stresses formed in the coatings as a result of these conventional processes can result in a brittle coating that is prone to crack propagation and coating spallation.

Accordingly, it is desirable to apply a hard wear resistant coating, particularly a bond coat layer, which is ductile and can prevent or substantially reduce problems with the hard coating, such as crack propagation and coating spallation.

### BRIEF DESCRIPTION OF THE INVENTION

According to one aspect of the invention, a process for applying a bond coat layer to a substrate includes cold spraying a first powdered material onto a surface of the substrate at a first velocity, wherein the first powdered material has a first particle size distribution; and cold spraying a second powdered material onto the surface at a second velocity to form the bond coat layer, wherein the second powdered material has a second particle size distribution and the bond coat layer comprises a microstructure comprising at least the first and second particle sizes.

According to another aspect of the invention, a process of applying a hard wear resistant coating to a substrate includes applying a bond coat layer to a surface of the substrate by cold spraying a multicomponent powdered material onto the surface, wherein the multicomponent powdered material comprises about 60 to about 70 weight percent of a first particle size distribution, about 20 to about 35 weight percent of a second particle size distribution, and about 5 to about 10 weight percent of a third particle size distribution, based on a total weight of the multicomponent powdered material; and applying at least one top layer onto the bond coat layer to form the hard wear resistant coating.

According to yet another aspect of the invention, a turbine engine component substrate includes at least one substrate surface; and a hard wear resistant coating comprising a bond coat layer and at least one top layer disposed on the at least one substrate surface, the bond coat layer being cold sprayed onto the at least one substrate surface, wherein the bond coat comprises a microstructure having a plurality of particles with a first particle size distribution, a second particle size distribution and a third particle size distribution.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a schematic illustration of an exemplary embodiment of a hard wear resistant coating on a substrate surface.

The detailed description explains embodiments of the invention, together with advantages and features, by way of example with reference to the drawings.

### DETAILED DESCRIPTION OF THE INVENTION

Disclosed herein are processes for applying the bond coat layer of a hard wear resistant coating. Specifically disclosed is a cold spraying process for applying the bond coat layer to a substrate. Cold spraying, also known as “cold gas dynamic spraying” is a technique for depositing powdered materials onto a substrate surface and is advantageous in that it provides sufficient energy to accelerate particles to high enough velocities such that, upon impact, the particles plastically deform and bond to the surface of the component being coated or onto a previously deposited layer. The cold spray process allows the build up of a relative dense coating or structural deposit. Cold spray does not metallurgically transform the particles from their solid state. In other words, cold spray application of a bond coat layer on the substrate avoids exposing the substrate to high temperatures and causing oxide layers in the coating.

The cold spraying processes disclosed herein uniquely utilize a multi-modal size distribution of powdered material feedstock to achieve a bond coat layer with a microstructure that consists of a mixture of fine and coarse grains. The fine grains of the uniquely cold sprayed bond coat layer in the hard wear resistant coating provide good fatigue properties, thereby resisting the low cycle fatigue often associated with coatings in turbine engine environments. The cold sprayed process herein produces a dense, heavily cold worked coating that create nano-sized sub-grains that lead to the formation a fine grain size microstructure that is beneficial to low cycle fatigue resistance. However, cracks can still occur in the fine grain portions of the bond coat layer and the coarse grains therein are beneficial in stopping or substantially slowing the propagation of the crack when it reaches the coarse grain microstructure. Moreover, in some applications, the same hard wear resistant coating will also require resistance to hold time fatigue at moderate temperatures (e.g., about 400-700 degrees Celsius (° C.)) where oxidation can occur along grain boundaries. To resist such fatigue, the pockets of larger grain size dispersed within the fine grained bond coat layer will prove beneficial. The cold spraying process herein can advantageously be used to control the grain size of the deposits on the substrate and from a bond coat layer having a combination of both fine and coarse grain sizes. The resulting cold sprayed bond coat layer yields a hard wear resistant layer that is resistant to crack propagation and low-cycle fatigue, while also resisting issues from oxidation and hold time fatigue problems. The result is a coating with a longer operating life, thereby giving a longer life to the component upon which the coating is disposed and reducing the amount of service intervals needed in the operating system, such as a turbine engine.

Again, the unique cold spray process described herein offers certain other advantages over conventional coating processes. Since the powders are not heated to high temperatures, no oxidation, decomposition, or other degradation of the feedstock materials occurs. Other potential advantages include the formation of compressive residual surface stresses and retaining the microstructure of the feedstock. Also, because relatively low temperatures are used, thermal distortion of the substrate will be reduced. Because the feedstock is not melted, cold spraying offers the ability to deposit materials that cannot be sprayed conventionally due to the formation of brittle intermetallics or a propensity to crack upon cooling or during subsequent heat treatments.

In order to achieve the varied grain size microstructure of the cold sprayed bond coat, a feedstock with a multi-modal particle size distribution is used. The feedstock of powdered material can be a single powder material having a variety of grain sizes, including fine and coarse grains, or the feedstock can comprise a multi-component powder mix with fine grains of a particular material(s) and coarse grains of a different material(s). In one embodiment, the feedstock includes one or more powdered materials having a first fine particle size, wherein the particles have a diameter of about 5 micrometers (μm) to about 15 μm, a second particle size with particle diameters of about 16 μm to about 25 μm, and a third particle size with diameters of about 26 μm to about 45 μm. In another embodiment, the powdered material of the feedstock includes about 60 to about 70 percent by weight (wt. %) of particles with a diameter of about 15 μm to about 22 μm; about 20 to about 35 wt. % particles with a diameter of about 15 μm to about 25 μm; and about 5 to about 10 wt. % of particles with a diameter of greater than or equal to about 45 μm, based on the total weight of the powdered material of the feedstock. This cold spray process enables the various feedstock particles to be accelerated above critical velocities, e.g., the velocities that provide sufficient energy such that, upon impact, the particles plastically deform and bond to the surface of the substrate, but the variety in particle size distribution ensures that particles of different diameter impact at different speeds resulting in a microstructure of fine, coarse, and mixed grain particles.

A compressed process gas, in which the particles are disposed, is accelerated to supersonic velocities. The gas forces the powder onto the substrate surface at speeds, typically in a range of between 300 meters per second (m/s) to 2000 m/s. The high-speed delivery causes the powder to adhere to the substrate surface and form the bond coating thereon. Of course it should be understood that delivery speeds can vary to levels below 800 m/s and above 1500 m/s depending on desired adhesion characteristics and powder type. For purposes of this process, it is not important that all of the material (e.g., particle sizes) in the feedstock be at the same speed, but rather that all of the material be above the critical velocity, even if the fine particles are traveling faster than the coarse particles. It is this difference in velocity that results in different impact forces at the substrate surface, which produces the desired difference in grain refinement throughout the deposited bond coat layer. The cold spray parameters, including delivery speed, can be tuned to achieve a pronounced cold working effect across the cross-section in feedstock particles of a particular size distribution. The multi-modal particle size distribution of the feedstock powder mix will experience different degrees of grain refinement during cold spray, whereby finer particles will be more grain refined than the larger, coarser particles. To some extent, the parameters of the cold spray process are tuned to control the grain size of the deposits. For example, increasing delivery speeds will result in higher particle velocities and finer grain size, while lower particle velocities result in coarser grain sizes.

In an exemplary embodiment, the bond coating is cold sprayed using a single spray gun conFIGUREd to create a multi-component powder mix that is delivered onto the substrate without the need for multiple distinct applications or tailoring application parameters to accommodate two or more different powders and/or particle size distributions. An exemplary spray gun for use with the cold spraying process herein is described in U.S. patent application Ser. No. 13/190,762, which is incorporated herein by reference in its entirety.

When applying the powdered coating materials to form the bond coat layer on the substrate surface, the spray gun nozzle can be held at a distance from the surface, known as the standoff distance. In one embodiment, the standoff distance is about 10 millimeters (mm) to about 100 mm.

The powdered materials used in the cold spraying process form a ductile bond coat layer providing a hard wear resistant coating having improved fracture toughness compared to those conventional hard wear resistant coatings that do not have such ductile bond coat layers formed as described herein, such as conventional tungsten carbide-cobalt chromium coatings (WC—CoCr) and chromium carbide-nickel chromium coatings (CRC/Ni—Cr). The hard wear resistant coatings with bond coat layers formed by the cold spraying processes described herein are better able to withstand the conditions experienced by the coatings, such as in a turbine engine operating environment. Exemplary materials for use to form the bond coat layer can include ductile materials such as, for example, nickel-based or cobalt-based superalloys, wherein the amount of nickel or cobalt in the superalloy is the single greatest element by weight. Exemplary nickel-based superalloys include, but are not limited to, approximately 40 weight percent nickel (Ni), and at least one component from the group consisting of cobalt (Co), chromium (Cr), aluminum (Al), tungsten (W), molybdenum (Mo), titanium (Ti), tantalum (Ta), Niobium (Nb), hafnium (Hf), boron (B), carbon (C), and iron (Fe). Examples of nickel-based superalloys may be designated by, but are not limited to, the trade names Inconel®, Nimonic®, Rene® (e.g., Rene®80-, Rene®95, Rene®142, and Rene®N5 alloys), and Udimet®, Hastelloy®, Hastelloy® S, Incoloy®, and the like. Incoloy®, Inconel® and Nimonic® are trademarks of Special Metals Corporation. Hastelloy® is a trademark of Haynes International. Alternatively, stainless steels such as 409, 410, 304L, 316, 321, and the like may be used. Exemplary cobalt-based superalloys include at least about 30 weight percent cobalt, and at least one component from the group consisting of nickel, chromium, aluminum, tungsten, molybdenum, titanium, and iron. Examples of cobalt-based alloys are designated by, but are not limited to, the trade names Haynes®, Nozzaloy®, Stellite® and Ultimet®. Stellite® is a trademark of Deloro Stellite.

The bond coat layer formed by the cold spraying process can then be covered by an additional layer or layers to form the hard wear resistant coating. The multilayer hard wear resistant coating can have two or more layers including the bond coat layer. Such coatings are well known to those having skill in the art. Additional layers in the hard wear resistant coating can include, for example, without limitation, wear resistant layers, intermediate layers, barrier layers, protective layers, and the like. The additional layers of the hard wear resistant coating can be disposed over the cold sprayed bond coat layer using conventional methods known to those skilled in the art and will depend largely upon the material chosen to form the layer. Exemplary methods for forming the layer(s) over the bond coat layer can include, without limitation, plasma spraying, high velocity plasma spraying, low pressure plasma spraying, solution plasma spraying, suspension plasma spraying, chemical vapor deposition (CVD), electron beam physical vapor deposition (EBPVD), sol-gel, sputtering, slurry processes such as dipping, spraying, tape-casting, rolling, painting, and combinations of these methods. Once coated the layer can optionally be dried and sintered.

The additional top layer or layers can comprise any coating material known in the art for reducing surface wear in a substrate coating caused by harsh conditions of the surrounding environment and/or physical contact with the projectiles. Exemplary materials for the wear resistant top layer(s) can include, without limitation, cobalt alloys such as L605 (Haynes® 25) or Haynes® 188 or Stellite® 6B, Nozzaloy®, Ultimet®, and the like, cermet materials such as, without limitation, tungsten carbide-cobalt chromium coatings (WC—CoCr), chromium carbide-nickel chromium coatings (CRC/Ni—Cr), and the like, rare earth silicates such as, without limitation, Y, Dy, Ho, Er, Tm, Th, Yb and/or Lu, having a general composition of RE₂SiO₅, or combinations thereof.

The FIGURE schematically illustrates an exemplary embodiment of a hard wear resistant coating 100 disposed on a substrate surface 102, the multilayer hard coating 100 includes one or more wear resistant top layers 106 disposed over the bond coat layer 104, which has been applied via the cold spraying process as described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A process for applying a bond coat layer to a substrate, comprising:
cold spraying a first powdered material onto a surface of the substrate at a first velocity, wherein the first powdered material has a first particle size distribution; and
cold spraying a second powdered material onto the surface at a second velocity to form the bond coat layer, wherein the second powdered material has a second particle size distribution and the bond coat layer comprises a microstructure comprising at least the first and second particle sizes.

2. The process of claim 1, wherein the first particle size distribution comprises a plurality of particles having a diameter of about 5 micrometers to about 15 micrometers.

3. The process of claim 1, wherein the second particle size distribution comprises a plurality of particles having a diameter of about 26 micrometers to about 45 micrometers.

4. The process of claim 1, further comprising cold spraying a third powdered material onto the surface at a third velocity, wherein the third powdered material has a third particle size distribution.

5. The process of claim 4, wherein the third particle size distribution comprises a plurality of particles having a diameter of about 16 micrometers to about 25 micrometers.

6. The process of claim 1, wherein the first velocity is greater than the second velocity.

7. The process of claim 5, wherein the third velocity is greater than the second velocity and less than the first velocity.

8. The process of claim 1, wherein the bond coat layer comprises a nickel-based superalloy comprising approximately 40 weight percent nickel, and at least one component from the group consisting of cobalt, chromium, aluminum, tungsten, molybdenum, titanium, tantalum, Niobium, hafnium, boron, carbon, and iron.

9. The process of claim 1, wherein the bond coat layer comprises a stainless steel.

10. The process of claim 1, wherein the bond coat layer comprises a cobalt-based superalloy comprising at least about 30 weight percent cobalt, and at least one component from the group consisting of nickel, chromium, aluminum, tungsten, molybdenum, titanium, and iron.

11. The process of claim 1, further comprising discharging the first powdered material and the second powdered material from a spray gun simultaneously.

12. A process of applying a hard wear resistant coating to a substrate, comprising:
applying a bond coat layer to a surface of the substrate by cold spraying a multicomponent powdered material onto the surface, wherein the multicomponent powdered material comprises about 60 to about 70 weight percent of a first particle size distribution, about 20 to about 35 weight percent of a second particle size distribution, and about 5 to about 10 weight percent of a third particle size distribution, based on a total weight of the multicomponent powdered material; and
applying at least one top layer onto the bond coat layer to form the hard wear resistant coating.

13. The process of claim 12, wherein the first particle size distribution comprises a plurality of particles having a diameter of about 15 micrometers to about 22 micrometers.

14. The process of claim 12, wherein the second particle size distribution comprises a plurality of particles having a diameter of about 15 micrometers to about 25 micrometers.

15. The process of claim 12, wherein the third particle size distribution comprises a plurality of particles having a diameter of equal to or greater than about 45 micrometers.

16. The process of claim 12, wherein cold spraying the multicomponent powdered material further comprises discharging the multicomponent powdered material from a spray gun at a critical velocity.

17. The process of claim 16, wherein the first particle size distribution is discharged at a first velocity, the second particle size distribution is discharged at a second velocity, and the third particle size distribution is discharged at a third velocity.

18. The process of claim 12, wherein the at least one top layer is applied by a coating method selected from the group consisting of plasma spraying, high velocity plasma spraying, low pressure plasma spraying, solution plasma spraying, suspension plasma spraying, chemical vapor deposition, electron beam physical vapor deposition, sol-gel, sputtering, and slurry process.

19. A turbine engine component substrate, comprising:
at least one substrate surface; and
a hard wear resistant coating comprising a bond coat layer and at least one top layer disposed on the at least one substrate surface, the bond coat layer being cold sprayed onto the at least one substrate surface, wherein the bond coat comprises a microstructure having a plurality of particles with a first particle size distribution, a second particle size distribution and a third particle size distribution.

20. The substrate of claim 19, wherein a diameter of a particle in the first particle size distribution is about 5 micrometers to about 15 micrometers; a diameter of a particle in the second particle size distribution is about 26 micrometers to about 45 micrometers; and a diameter of a particle in the third particle size distribution is about 16 micrometers to about 25 micrometers.
